(19) United States
(12) Patent Application Publication
(10) Pub. No.: US 2010/0032021 A1
(43) Pub. Date: Feb. 11, 2010

(54) FRACTION COLLECTOR DIVERTER VALVE

(76) Inventor: Herbert J. Hedberg, N. Attleboro, MA (US)

Correspondence Address: CESARI AND MCKENNA, LLP, 88 BLACK FALCON AVENUE, BOSTON, MA, 02210, US

(21) Appl. No.: 12/538,910

(22) Filed: Aug. 11, 2009

Related U.S. Application Data
(60) Provisional application No. 61/188,572, filed on Aug. 11, 2008.

(51) Int. Cl. F15D 1/14; F16K 21/00

(52) U.S. Cl. 137/1; 137/625

(57) ABSTRACT

A diverter valve assembly includes a standard three-way valve and an upstream two-way valve and a further upstream eluant accumulator. When a new container is required for collection, the two-way valve stops the flow from the source. Since the source flow is continuous, the flow is directed into the accumulator pushing a spring loaded piston. When the new container is in position, the two-way valve opens and eluant flow from the source and the accumulator are directed to the new container. There is no flow to waste during the stoppage of flow.

### RELATED APPLICATIONS

The present application claims priority from the U.S. Provisional Application Ser. No. 61/188,572, titled: “Extended-function Diverter Valve for Fraction Collector includes Stop-flow Valve and Low Dispersion Eluant Accumulator” filed Aug. 11, 2008. This provisional application is incorporated herein by reference.

### BACKGROUND

1. Field of the Invention

This disclosure relates generally to fraction collectors commonly used in purification and other analysis apparatuses. A fraction collector diverter valve diverts an eluant flow to waste while an empty container replaces another container under an output for filling. It also diverts uninteresting material to waste instead of using collection containers unnecessarily.

2. Background

Fraction collectors are prevalent in virtually all mixture purification apparatus. They are designed to periodically redirect the eluant flow stream from a chromatograph or other separation-producing apparatus. Typically the fraction collector will direct the flow to waste at the beginning of a separation run and then periodically during the run, the fraction collector is directed to divert the eluant flow from waste to one of an array of collection containers. When a container nears its capacity, but before overflowing, the flow is redirected to the next empty container in the array. At the end of the separation run or whenever the eluant stream contains no desired compounds, the flow may be diverted to waste so as not to fill collection containers unnecessarily.

The common implementation for the diverter valve function is to use a 3-way electrically actuated solenoid valve. The common (COM) inlet of the valve accepts the eluant flow from the chromatograph and the normally-open (NO) outlet delivers the eluant stream to the waste connection tubing of the system. When it is necessary to collect the eluant stream, the solenoid is powered, which in turn diverts the eluant from the NO port (waste) to the normally closed (NC) outlet. The NC port is plumbed to a nozzle which directs the flow into one of the collection containers.

A problem results, however, when it is necessary to switch from one collection container to the next. To avoid spraying the eluant stream into the spaces between the collection containers, the diverter valve is typically momentarily switched to waste until the nozzle is repositioned above the new empty collection container. Discontinuing the flow during the transition also prevents splashing on the lips of the containers, potentially contaminating adjacent containers in the collection array. Avoiding contamination of collection containers with material other than those compounds which eluted from the chromatograph at a given point in the separation run is critical to acceptable fraction collector function.

Further, if a container change is necessary (e.g., to avoid overfilling the current container) while the eluant stream continues to be collected, the switch to waste during container changes causes some loss of eluant. If the eluant stream is being continuously collected, then presumably the compounds dissolved in the eluant flow at that point in the separation run are of great interest to the researcher and potentially extremely valuable. Loss of any purified compound material to waste for the sake of preserving fraction purity is a troublesome and frustrating compromise offered by existing fraction collector instruments.

### SUMMARY OF THE INVENTION

This disclosure includes a two-way normally open (NO) type solenoid valve that is added to the flow path upstream from a standard three-way valve. The two-way valve stops the eluant flow during the repositioning of the dispensing nozzle to dispense into an empty container. When the eluant flow is stopped, an eluant accumulator is placed upstream from the two-way valve. The eluant accumulator momentarily stores the eluant or solvent from the source, since the source flow is continuous—usually from a chromatograph. By adding these two functions to the standard 3-way waste-collect diverter valve, the eluant stream flowing into the fraction collector is not wasted or stopped during a container change.

### BRIEF DESCRIPTION OF THE DRAWINGS

FIG. 1 is a drawing of a flow path through a diverter valve illustrating flow to waste;

FIG. 2 is the same drawing of FIG. 1 except the flow is directed into a container;

FIG. 3 is the same drawing of FIG. 2 except the flow is accumulated with no flow to waste or a container;

FIG. 4 is the same drawing of FIG. 2 except the flow is partially from the accumulator;

FIG. 5 is an alternative design where the accumulator is in-line with the flow stream; and

FIG. 6 is the design of FIG. 5 except the flow is into the accumulator.

### DETAILED DESCRIPTION OF AN ILLUSTRATIVE EMBODIMENT

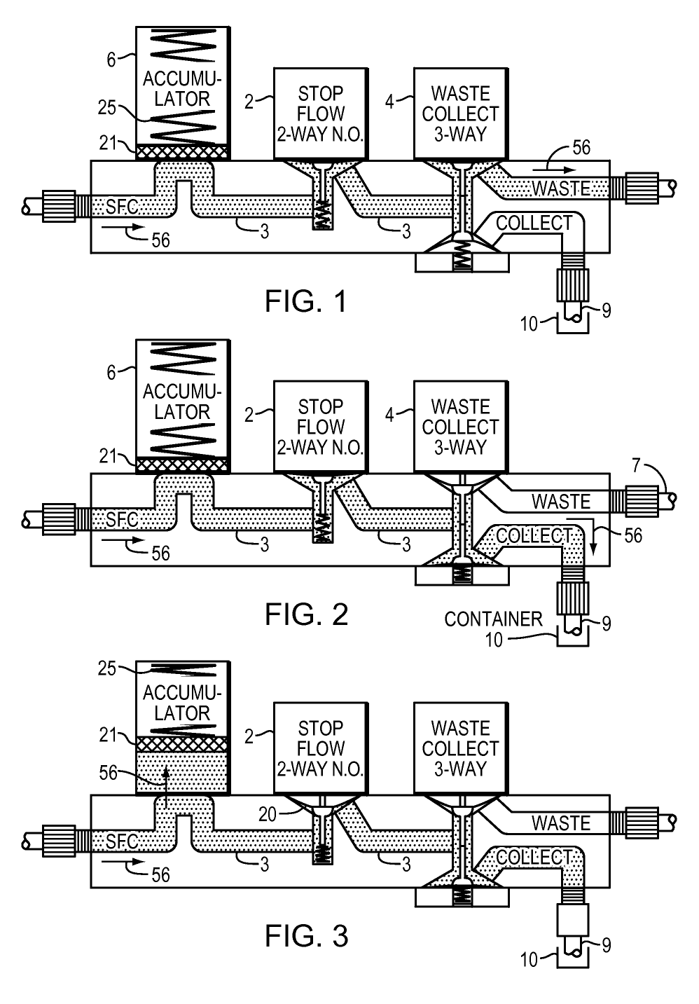

FIG. 1 shows a two-way NO stop-flow solenoid activated valve 2 (herein after a two-way vale) placed in the eluant flow path 3 just upstream of a three-way valve 4. The three way valve directing flow to waste or to a dispensing nozzle 9 and into a container 10. Also inserted in the flow path 3 upstream of the two-way valve is an eluant accumulator 6. This accumulator 6 employs a spring driven sliding piston in a cylinder that accepts flowing eluant (the arrows 56 indicate flowing eluant) when the flow through the two-way valve 2 is stopped by activating two-way valve 2. The spring 25 seats the piston 21 assuring that there is no mixing volume to the eluant flow path during normal collecting conditions. Unswept volumes along the flow path between the chromatographic column outlet and the containers in the fraction collector allow the concentrated bands of separated compound in the eluant flow to remix and thereby reduce the efficiency of the purification process.

In FIG. 2 the three-way valve 4 is activated allowing the flow stream to be redirected via the nozzle 9 into the container 10 for collection and away from the waste tube 7. Note that the accumulator piston 21 is pressing on flow path 3 access to avoid adding any mixing volume to the flow path 3.

FIG. 3 shows the two-way closed blocking the flow of eluant during a container change. Note the seated diaphragm 20 preventing eluant from passing. Because the eluant flow 56 from the chromatograph is continuous, pressure builds in the flow path 3 upstream of the two-way valve. Eventually, the rising pressure will overcome the force of the spring 25 on the back of the piston 21 and the piston will slide in the cylinder displacing a volume 56 that accepts the continuously flowing eluant. The rising pressure is produced by the compressed spring 25 behind the piston. The accumulator piston 21 provides a temporary holding volume for the continuously flowing eluant stream. While the eluant is accumulating in the accumulator 6 a new container 10 is positioned at the dispensing nozzle 9.

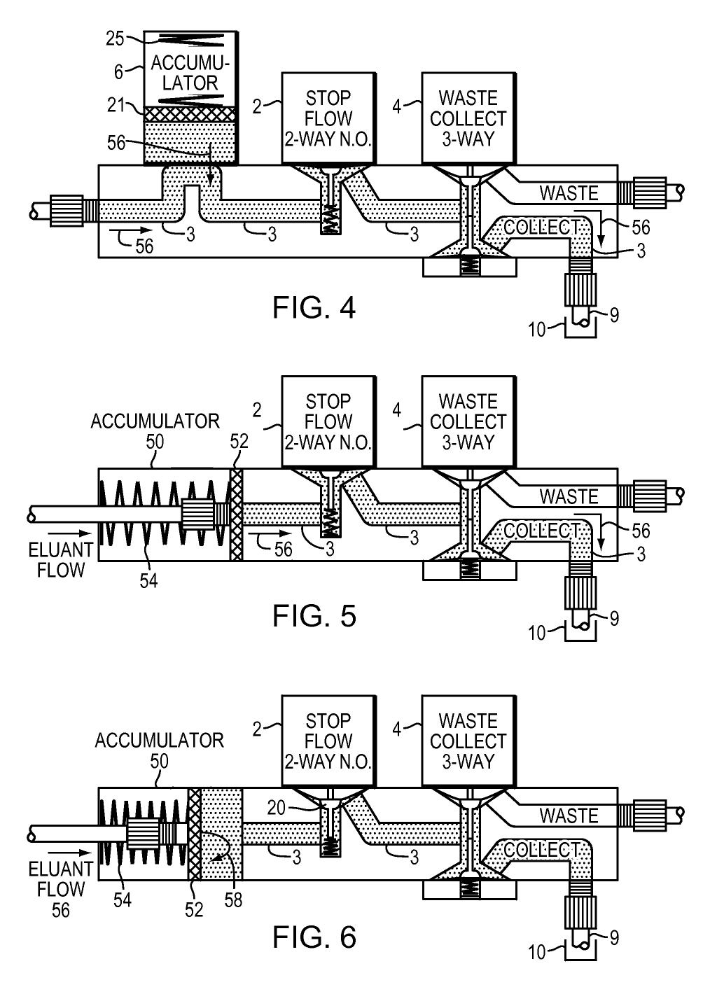

FIG. 4 illustrates the condition when the two-way valve is de-energized opening the flow path 3 to the new container 10. Because the downstream pressure is greatly reduced when the two-way opens, the spring 25 presses the piston back to its zero-volume position against the manifold end-cap. The stored eluant liquid in the accumulator volume combines with the current eluant flow 56 and both volumes are collected together in the new collection container 10.

In practical system with flow rates in the tens to hundreds of g/min, the spring 25 loaded piston 21 in the accumulator 6 prevents any pressure spike when the various valves are activated or deactivated. This ensures that the pressure ratings of the valves will not be exceeded even if there is a very short actual stoppage of flow. At lower flow rates in the 1-20 g/min, there is enough compliance in the system tubing to prevent any harmful pressure spikes.

FIG. 5 illustrates an alternative embodiment where the accumulator 50 piston is co-axial with the eluant flow path 3 that travels through the center of the piston. The piston 52 is spring 54 loaded. When, as shown in FIG. 6, the two-way valve 2 stops the flow by seating the diaphragm 20, the flow 56 turns 58 and drives the piston compressing the spring 54. During this time a new container 10 may be positioned under the nozzle 9 whereupon the two-way valve opens and the eluant flow adds to the volume stored in the accumulator 50 and the total flow passes into the container 10. Again, when the accumulator 50 is empty there is no unswept volume in the flow path 3.

This disclosure describes a valve and accumulator device which addresses specific requirements which arise especially with SFC separation instruments. The rapidly expanding CO₂ gas flowing to the fraction collector requires an especially large accumulator volume because although the SFC instrument may be flowing liquid CO₂ at 40 g/min, when it reaches the fraction collector diverter valve the eluant flow is mostly gas and a methanol mist flowing at 20 liters/min.

A significant side benefit of having an integrated accumulator with the stop-flow valve is the capability for the CFC-2 centrifugal fraction collector to successfully operate with HPLC instruments. In these systems, there is no compressible gas phase at the eluant outlet which makes stop-flow functionality possible at the lowest flow rates of CO₂. But now, the accumulator provides the ability to temporarily store incompressible HPLC eluant at any flow rate while the dispensing nozzle is being repositioned and the flow is blocked.

What is claimed is:

1. A diverter apparatus in an eluant flow path to a container, the diverter apparatus comprising:
a two-way valve located in the eluant flow path, the two-way valve having one state where the flow path is blocked and another state where the flow path is open; and
an accumulator accessing the eluant flow path upstream from the two-way vale; wherein when the two-way valve blocks the eluant flow, the eluant flow is directed into the accumulator, and when the two-way valve opens, the eluant flows from the source and from the accumulator to a container.

2. The diverter valve of claim 1 wherein the accumulator comprises:
a spring loaded piston, wherein the piston is flush with the flow path and presents no added volume to the flow path when the accumulator contains no eluant.

3. The diverter valve of claim 1 further comprising a three-way valve placed down stream from the two-way valve, the three-way valve having two selected outputs one directed to waste and the other to one of a multi-container array of collection vessels or to a multi-port liquid switching valve to direct flow to a specific collection tubing connection.

4. The diverter valve of claim 2 wherein the accumulator piston has a center axis that is co-axial with the center axis of the flow path.

5. A process for diverting an inflowing eluant flow, the process comprising the steps of:
blocking the eluant flow path so that no eluant is flowing to a first container, wherein the eluant is diverted to an accumulator;
accumulating the eluant;
re-placing the first container with a second container.
opening the eluant flow path to the second container; and
delivering eluant flow to the second container partially from the accumulated eluant and partially from the inflowing eluant flow.

6. The process of claim 5 wherein the accumulating of the eluant comprises the steps of:
driving a piston against a spring, wherein a volume is opened by the moving piston;
diverting the eluant flow into this volume, and
returning the piston to its initial location with a spring, wherein there is no unswept volume in the eluant flow path

7. The process of claim 5 wherein the accumulator piston has a center axis that is co-axial with a center axis of the flow path.

8. A process for diverting an eluant flow path to a container, the process comprising the steps of:
stopping the eluant flow to a first container;
replacing the container with a second container;
accumulating the eluant flow, while the flow to the first container is stopped, and, when the second container is in place;
directing flow to the second container; and
releasing volume accumulated during the time the eluant flow is stopped to the first container.
